(19) United States
(12) Patent Application Publication
(10) Pub. No.: US 2011/0264301 A1
(43) Pub. Date: Oct. 27, 2011

(54) METHOD FOR DETERMINING A TRAVEL DIRECTION AND CONTROL DEVICE FOR A VEHICLE SYSTEM

(76) Inventors: Immanuel Henken, Lauenau (DE); Tobias Munko, Hannover (DE); Gerhard Ruhnau, Neustadt (DE); Axel Stender, Hameln (DE); Ingo Tha, Hannover (DE)

(21) Appl. No.: 13/128,152

(22) PCT Filed: Aug. 8, 2009
(86) PCT No.: PCT/EP2009/005779

§ 371 Date: Jul. 8, 2011

(30) Foreign Application Priority Data
Nov. 8, 2008 (DE) 10 2008 056 529.6
May 9, 2009 (DE) 10 2009 020 594.2

(51) Int. Cl. G06F 7/00; G01P 15/00

(52) U.S. Cl. 701/1; 73/514.01

(57) ABSTRACT

The invention relates to a method for determining a travel direction of a vehicle (1), particularly a trailer vehicle, wherein wheel speed signals (n1, n2, n3) are captured and a travel speed (v) is determined, a longitudinal acceleration (a) of the vehicle (1) is measured, and a longitudinal acceleration measurement signal (Sa) is output, an approach process is determined from a time change in the travel speed (v), and the direction of the approach process is determined from the longitudinal acceleration measurement signal (Sa). An approach process in the reverse direction is particularly detected thereby. The invention further relates to a control device (2) for performing the method, particularly in a vehicle controller, a vehicle system, and a corresponding vehicle.

The present invention generally relates to embodiments of a method for determining a travel direction, a control device for a vehicle system, such a vehicle system and a vehicle having such a vehicle system.

The measurement of the velocity of a vehicle is generally carried out by means of the wheel speeds, which are determined by the wheel speed sensors of the individual wheels. The wheel speed sensors are, for example, embodied as inductive sensors, which determine changes in the inductance or in the magnetic flux of an air gap with respect to teeth or teeth edges of a metal disk as the vehicle wheel rotates. By means of, for example, edge detection it is therefore possible to reliably determine the wheel speed; in particular in the case of passive wheel speed sensors it is, however, still not possible to determine the travel direction from the wheel speed signal.

In order to determine the travel direction by means of the wheel speed sensors, it is known to use a double sensor at least one wheel. As a result, edges of the two sensors can be monitored with respect to their sequence, which directly results in the travel direction. However, in the first instance, such double sensors entail relatively high costs. Furthermore, the distances between the double sensors and the distances between the tooth edges have to be matched precisely to one another.

It is an object of the present invention to provide a method for determining a travel direction, a control device and a vehicle system using the control device and a method with which relatively simple and sufficiently precise determination of the travel direction is possible.

This object is achieved by means of a method as claimed in claim 1, a control device as claimed in claim 11, a vehicle system as claimed in claim 20 and a vehicle as claimed in claim 23. The dependent claims describe preferred developments.

The claimed invention is based on the idea of determining the travel direction from wheel speeds of simple wheel speed sensors and from an additionally measured longitudinal acceleration signal of the vehicle. For this purpose, a starting process is advantageously detected and in the process the travel direction, which can subsequently only change again in a stationary state and subsequent starting process, is determined.

The wheel speed sensors serve here to determine a velocity and/or the absolute value of the velocity, in order, in particular, to determine a starting process, wherein according to embodiments of the invention, in particular, a starting process is detected in the rearward direction. In this context it is used to determine whether at a first time a stationary state of the vehicle in which the velocity is zero and/or is below a sufficiently low threshold value of, for example, 2 km/h is present, since at low velocities the resolution is made more difficult owing to the edge signals having large chronological intervals between them. If the velocity signal subsequently rises after a stationary state is detected and at the same time a longitudinal acceleration directed in the rearward direction is determined, according to embodiments of the invention it is decided that a starting process in the rearward direction is occurring. The rearward travel state that is determined in this way can subsequently be stored, for example by setting a flag or storing a value in a memory until a stationary state of the vehicle is subsequently determined again.

The control device or the control unit of a vehicle movement dynamics control system, in particular an ABS and/or an electronic stability system, is advantageously used as the control device. If the control device already has such a longitudinal acceleration sensor in any case, no additional hardware expenditure is necessary. Furthermore, a combined lateral acceleration and longitudinal acceleration sensor can also be provided; many vehicles, in particular also trailer vehicles, already have a lateral acceleration sensor for their vehicle movement dynamics control process. The use of a combined longitudinal acceleration and lateral acceleration sensor is not significantly more costly or complex compared to a pure lateral acceleration sensor. According to embodiments of the invention it is therefore possible, by means of a small amount of additional hardware, which is significantly less than the use of a double sensor on a vehicle wheel, to carry out reliable detection of the travel direction. In this context, if appropriate, it is additionally possible for the longitudinal acceleration to also be used to determine critical travel states and/or the vehicle movement dynamics control process.

The rearward travel signal that is determined can, according to embodiments of the invention, in particular, also be output in a detectable fashion to the rear, for example by means of an acoustic output device that outputs a warning signal when rearward travel is detected. It is therefore possible for an acoustic warning that the trailer is traveling in a rearward direction to be output directly from the trailer vehicle to persons and vehicles located behind it. In addition, an optical signal can also be output, for example directly by actuating reversing lights.

According to one advantageous embodiment of the invention, the installation position of the longitudinal acceleration sensor can be checked and/or learnt automatically. This learning can, for example, be carried out by determining acceleration processes at sufficiently high velocities. If, for example, a vehicle is subjected to relatively strong acceleration at a relatively high velocity, this can be reliably detected as a deceleration direction and differentiated from an acceleration process. In particular, in the case of trailer vehicles of trucks, the accelerations that can be achieved at a relatively high velocity of, for example, 50 km/h are reliably significantly lower than the decelerations that can be achieved.

According to embodiments of the invention, in particular, a starting process is determined in order to avoid incorrectly determining a deceleration process or a braking process in which an acceleration is also measured in the rearward direction from being determined as rearward travel. The starting process can be sufficiently reliably detected from the velocity values, and this therefore rules out corresponding misinterpretations.

Furthermore, an additional plausibility check can be carried out, for example also by reading out certain critical travel states. If, for example, braking on a smooth underlying surface or gravel or sand leads to locking wheels and therefore to wheels that suddenly adopt a stationary state, with a longitudinal acceleration toward occurring at the same time owing to the braking, and subsequently the wheels are entrained by the underlying surface and therefore again indicate a rise in velocity, this can be differentiated by a starting process in the rearward direction in which case a detected ABS intervention case rules out the outputting of a rearward travel signal.

The invention will be explained in more detail below by means of an illustrative embodiment and on the basis of the appended drawings, in which:

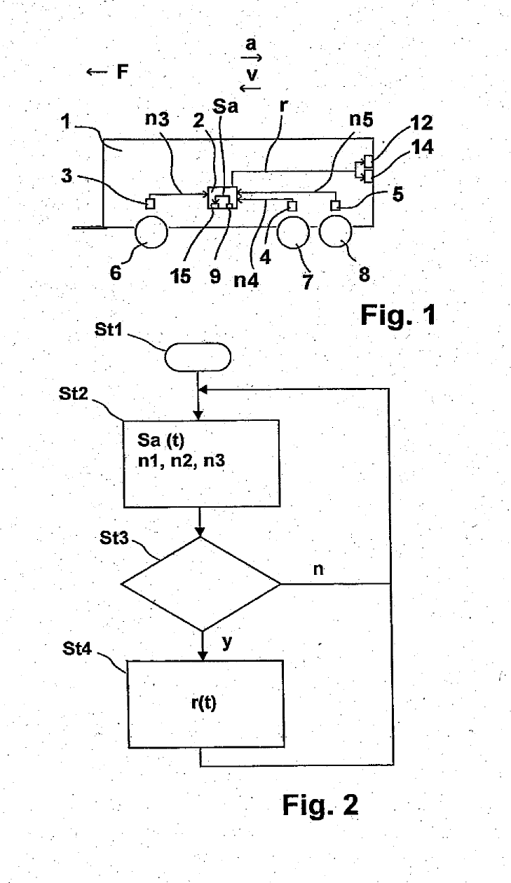

FIG. 1 is a block diagram of a trailer vehicle according to the invention; and

FIG. 2 is a flowchart of a method according to the invention,

In FIG. 1, a trailer vehicle is shown as the vehicle 1, which trailer vehicle can, for example, be embodied as a trailer or semitrailer and is provided for connection to a towing vehicle; however, the invention can basically also be implemented with a motorized vehicle. The travel direction F points forward, and correspondingly the rearward direction points in the direction that is opposed to F.

A control device 2 receives wheel speed signals ni where i=1, 2, 3 . . . of wheel speed sensors 3, 4, 5 of the wheels 6, 7, 8 of all or of some of the axis of the vehicle 1. Furthermore, a longitudinal acceleration sensor 9 is provided in or on the vehicle 1; according to the embodiment shown the longitudinal acceleration sensor 9 can be provided directly in the control device 2 and can supply longitudinal acceleration measurement signals Sa that are received and processed by a computing device 10 in the control device 2 together with the wheel speed signals ni.

The control device 2 can, in particular, be embodied as a control unit 2 that serves for a vehicle control process, for example a vehicle movement dynamics control process or a braking control process. In this context, the longitudinal acceleration sensor 9 can be embodied as a combined longitudinal acceleration and lateral acceleration sensor since such a combined design is cost-effective and provides a saving in terms of installation space on the printed circuit board.

According to embodiments of the invention, the control device 2 determines, in a manner known per se, from the wheel speeds ni the individual speeds of the wheels 3, 4, 5 and therefore also a velocity v (t) as a function of the time t. During this determination the rotational speed of the respective wheels 6, 7, 8 and therefore the absolute value of the speed is determined (in a manner known per se which is therefore not described in greater detail) from the edges of the wheel speed signals n3, n4, n5; and the vehicle velocity v (t), which is determined overall, is therefore a positive absolute value independent of the travel direction. It is not possible to directly determine the travel direction from the wheel speed sensors 3, 4, 5 that are used here.

The time-dependent longitudinal acceleration measurement signal Sa (t), which is additionally used according to embodiments of the invention, initially indicates the direction of an acceleration or a deceleration. According to the arrow indication in FIG. 1, the acceleration a in the travel direction is denoted as being positive and therefore correspondingly the acceleration in the rearward direction is denoted as being negative. A negative, measured longitudinal acceleration a (t) can initially be a deceleration or braking here during normal travel in the forward direction or an acceleration in the rearward direction.

According to embodiments of the invention, it is respectively determined from the measurement signals whether a starting process occurs from the stationary state in the rearward direction, and when such a starting process is detected in the rearward direction a signal r is output.

According to the flowchart in FIG. 2, the process is therefore started in step St1, for example when the towing vehicle starts and therefore when the vehicle movement dynamics control process is initiated by the control device 2 of the vehicle 1 or trailer vehicle 1. In step St2, the wheel speeds ni, i=1, 2, 3, . . . of the individual wheels 6, 7, 8 of the vehicle 1 are determined continuously and received by the control device 2. Furthermore, the longitudinal acceleration is measured continuously by means of the longitudinal acceleration sensor 9, and the signal Sa (t) is output.

In the decision step St3 it is determined whether:
a) a stationary state, i.e., v (t0)=0 or v (t0)≦vmin≈2 km/h occurs at a time t(0), since in general velocities below vmin≈2 km/h cannot be further differentiated and therefore cannot be differentiated from the stationary state. Furthermore it is determined whether
b) v (t)>0 for t>t0, i.e. a starting process is occurring, and
c) Sa (t)<0 for t>t0, i.e. the starting process is occurring with an acceleration in the negative direction, i.e. in the rearward direction.

In the equations a), b) and c), in each case the time period t>t0 is relevant here for all times t that follow t0. If therefore the starting process initially occurs in the forward direction, i.e., Sa (t)>0, according to a) a stationary state must initially be present again before a starting process can take place in the rearward direction.

If the conditions a), b) and c) are met, a starting process in the rearward direction is therefore detected in the decision step St3. In this case, according to the branching y the rearward travel signal r is output; for this purpose a flag can be set or this value can be stored in a memory, with the result that the subsequent travel process is respectively detected as being rearward travel. According to step St4, a process can subsequently be actuated with the rearward travel signal r, for example an acoustic signal can be output by means of an acoustic output device 12 and/or a light signal can be output in the rearward direction by means of a reversing light 14. Furthermore, the signal r, which is determined, can basically also be output to another vehicle, for example the towing vehicle, for example for a plausibility check.

If no starting process in the rearward direction is determined, the method is respectively reset here before step St2 after step St4 or else in the case n of the decision step St3, and therefore carried out continuously.

A plausibility check can also additionally take place here in step St3 in order to avoid incorrectly subsequently detecting a starting process in the rearward direction in the case of, for example, a skidding state in which the wheels 6, 7, 8 are stationary but the vehicle 1 is moving, i.e. v≠0 applies. If the wheels 6, 7, 8 therefore firstly lock in a skidding state and a stationary state of the wheels is therefore determined from the wheel speeds ni=0, it is therefore possible to avoid a starting process in the rearward direction being subsequently incorrectly determined owing to the braking with a negative Sa, which is determined when in the case of an ABS intervention the wheels 6, 7, 8 are released and therefore start to rotate again.

Furthermore, according to embodiments of the invention the installation position of the longitudinal acceleration sensor 9 can be checked and/or learnt automatically. This learning can, for example, be carried out by determining braking processes or deceleration processes at sufficiently high velocities v. If the vehicle 1 is subjected to relatively strong acceleration a at a relatively high velocity, this direction of the acceleration a can be reliably detected as a deceleration direction, i.e., counter to the travel direction, and can be differentiated from an acceleration process.

1. A method for determining a travel direction of a vehicle (1), in which
wheel speed signals (n1, n2, n3) are received and a velocity (v) is determined,
a longitudinal acceleration (a) of the vehicle (1) is measured, and a longitudinal acceleration measurement signal (Sa) is output, a starting process is determined from a change in the velocity (v) over time, and
the direction of the starting process is determined from the longitudinal acceleration measurement signal (Sa).

2. The method as claimed in claim 1, characterized in that during the determination of a starting process it is checked whether the velocity (v) which is determined at a first time (t0) is essentially zero or below a minimum value (vmin) and is subsequently greater than zero or the minimum value (vmin) in absolute value.

3. The method as claimed in claim 1 or 2, characterized in that, in addition, a plausibility check is performed during which a starting process is differentiated from an unstable skidding state.

4. The method as claimed in one of the preceding claims, characterized in that the wheel speed signals (n1, n2, n3) are free from a direction sign or algebraic sign, and the velocity (v) which is determined from the wheel speed signals (n1, n2, n3) is a positive value independently of the travel direction.

5. The method as claimed in one of the preceding claims, characterized in that an installation position of the longitudinal acceleration sensor (9) is checked and/or is learnt automatically from one or more braking processes and/or acceleration processes.

6. The method as claimed in claim 5, characterized in that the installation position of the longitudinal acceleration sensor (9) is checked and/or is learnt automatically as a function of the magnitude of the acceleration (a) and the magnitude of the velocity (v).

7. The method as claimed in claim 6, characterized in that the installation position of the longitudinal acceleration sensor (9) is checked and/or is learnt automatically by virtue of the fact that, given a sufficiently high absolute value of the velocity (v) and a sufficiently high absolute value of the acceleration, an acceleration in the rearward direction is detected.

8. The method as claimed in one of the preceding claims, characterized in that in addition to the longitudinal acceleration a lateral acceleration of the vehicle (1) is determined, and the longitudinal acceleration measurement signal and the lateral acceleration measurement signal are used for a vehicle movement dynamics control process, for example anti-lock brake control process and/or stability control process.

9. The method as claimed in one of the preceding claims, characterized in that during the determination of rearward travel a rearward travel signal (r) is output.

10. The method as claimed in claim 9, characterized in that when the rearward travel signal (r) is output a light signal and/or an acoustic signal are/is output.

11. A control device (2) for a vehicle system,
wherein the control device (2) receives and evaluates a longitudinal acceleration measurement signal (Sa) of a longitudinal acceleration sensor (9) of the vehicle (1) and wheel speed signals (n1, n2, n3) of wheel speed sensors (3, 4, 5) of the vehicle (1) or a velocity signal (v) which is determined from the wheel speed signals (n1, n2, n3), wherein the control device (2) has a computing device (15) which determines, from a change in the velocity (v) over time, whether a starting process is present and determines the direction of the starting process from the longitudinal acceleration measurement signal (Sa).

12. The control device as claimed in claim 11, characterized in that when a starting process in the rearward direction is detected said control device outputs a rearward travel signal (r) in the rearward direction.

13. The control device as claimed in claim 11 or 12, characterized in that the computing device (15) determines the velocity (v) of the vehicle (1) from the wheel speed signals (n1, n2, n3).

14. The control device as claimed in one of claims 11 to 13, characterized in that said control device checks whether the velocity (v) which is determined at a first time (t0) is essentially zero or below a minimum value (vmin) and is subsequently greater than zero or the minimum value (vmin) in absolute value.

15. The control device as claimed in claim 14, characterized in that said control device detects a starting process in the rearward direction if the velocity (v (t)) subsequently increases from a value below a minimum value (vmin) and at the same time the longitudinal acceleration measurement signal (Sa (t)) indicates a longitudinal acceleration (a (t)) which is directed in the rearward direction.

16. The control device as claimed in claim 15, characterized in that the computing device (15) also checks whether an unstable travel state, in particular a skidding state of the vehicle (1) is present, and when the unstable travel state is present said computing device (15) does not detect a starting process in the rearward direction.

17. The control device as claimed in one of claims 11 to 16, characterized in that said control device is the control device of a vehicle movement dynamics control system and outputs control signals for wheel brakes and/or air springs of the wheels (6, 7, 8) of the vehicle (1).

18. The control device as claimed in one of claims 11 to 17, characterized in that the longitudinal acceleration sensor (9) is part of the control device (2).

19. The control device as claimed in claim 18, characterized in that said control device also has a lateral acceleration sensor, preferably a combined longitudinal acceleration and lateral acceleration sensor (9), for carrying out the vehicle movement dynamics control process.

20. A vehicle system of a vehicle (1) which has:
a control device as claimed in one of claims 11 to 19, and a longitudinal acceleration sensor (9) which is provided in or outside the control device (2).

21. The vehicle system as claimed in claim 20, characterized in that said vehicle system is a vehicle movement dynamics control system which also has:
wheel speed sensors (3, 4, 5) which are provided on wheels (6, 7, 8) of the vehicle (1), and
actuating devices which are driven by the control device (2) and are, in particular, wheel brakes and/or pneumatic ride level control devices,
wherein the control device (2) carries out a vehicle movement dynamics control process, for example an anti-lock brake system and/or a vehicle stability control system, as a function of the determined wheel speeds (n1, n2, n3), of the longitudinal acceleration measurement signal (am (t)) and the received brake signals.

22. The vehicle system as claimed in claim 21, characterized in that said vehicle system carries out a stability control process using at least the longitudinal acceleration measurement signal (am (t)) and a lateral acceleration measurement signal (q).

23. A vehicle having a vehicle system as claimed in one of claims 20 to 22.
